(19) United States
(12) Patent Application Publication
(10) Pub. No.: US 2004/0265458 A1
(43) Pub. Date: Dec. 30, 2004

(54) Apparatus and method for treating food products and especially for defrosting a frozen food

(76) Inventor: Anthony S. Christopher, Montgomery, TX (US)

Correspondence Address: TIMOTHY J MARTIN, PC, 9250 W 5TH AVENUE, SUITE 200, LAKEWOOD, CO, 80226, US

(21) Appl. No.: 10/819,892

(22) Filed: Apr. 6, 2004

Related U.S. Application Data
(60) Provisional application No. 60/461,244, filed on Apr. 8, 2003.

(51) Int. Cl. A23C 3/00

(52) U.S. Cl. 426/524

(57) ABSTRACT

An apparatus and method for treating a food product such a defrosting, warming or cooling includes a water jacket with an insulating layer that forms a water chamber to receive and store water at a selected temperature. The water jacket has an inlet port and an interior region to receive the food product. A layer of insulating material extends around a majority of the water jacket, and a door allows access to the interior region. An outlet port separate from the inlet port may be provided. The inlet port may also slide between a stored state and a fill state. A separate shell is optionally provided surrounding the water jacket. A thermally conductive plate may also be included in the interior region. The method is directed to defrosting a food product by placing it in the apparatus as described.

### FIELD OF THE INVENTION

The present invention broadly concerns food storage and handling. More particularly, however, the present invention is directed to a food handling apparatus and a method for defrosting food products, such as meats, poultry, breads, vegetables and the like. This invention specifically concerns a stand-alone defrosting apparatus which defrosts food using convection air as the heat transfer medium.

### BACKGROUND OF THE INVENTION

Throughout history, there has been a need to handle and store food and related products. One early preservation technique involved drying a food product so that its useable life was extended. For example, primitive cultures dried fruits such as plums, grapes, dates and the like as well as the drying of meats into jerky and pemmican. Early techniques of the preservation of meats also included smoking, salting and the treatment of the meats with other chemicals, such as lye. Moreover, in some cultures that had access to ice, cooling or freezing of food items was developed as a preservation method.

In more modern times, of course, the development of refrigeration has dramatically altered the ability for people worldwide to store food products. Refrigerators maintain an environment that is substantially colder than the surrounding environment, but this temperature is usually above a freezing temperature. Freezers, on the other hand, create a refrigerated environment that is substantially lower, often around 0° Fahrenheit (about −18° C.), since foods are preserved longer at these lower temperatures. Many household refrigerators are actually a combination of a refrigerator and a freezer.

In any event, the ability to freeze food products has been a great boon to human kind. However, many food preparers often need to thaw or “defrost” a frozen food product before it is further processed for consumption. Due to the thermal capacity of some food products, thawing the item from a frozen state can take an unacceptably long time, depending upon the circumstances. Accordingly, it is sometimes desirable to accelerate the thaw time for a food product after it has been removed from a freezer.

Various techniques are common for thawing a frozen food product. Some people merely expose the food product to ambient air. Sometimes, the food product is placed in a water bath or under a running stream of water to accelerate the defrosting. Each of these has disadvantages. For example, thawing the frozen food item at ambient temperatures or in a water bath can increase the likelihood of bacteria buildup on the food product which can create an unhealthy condition. Thawing a food product under a running stream of water is wasteful of resources and also may expose the food product to bacteria.

It is also known to place a food product on a thermally conductive plate in ambient environment. This technique can decrease the thaw time of a food product if there is sufficient thermal conduction between the food product and the thermally conductive plate. In essence, the thermally conductive plate provides a heat sink with larger exposed surface by which heat may be conducted and exchanged with the ambient air environment.

In more recent times, it has become known to defrost food products using microwave energy. While this technique can thaw food in an extremely short time, it is difficult to keep portions of the food from prematurely cooking. Indeed, many people think that the thawing of food products with microwave energy lessens the taste of the final food product.

Despite these approaches to the defrosting of food, there remains the need for better techniques that can rapidly and safely thaw food from a frozen state to a more useable state. There is further need for an apparatus and method which can facilitate the thawing of frozen food products in a short, efficient and relatively safe manner. There is a further need for such apparatus that is easy to manufacture, compact in size and relatively inexpensive. The present invention is directed to meeting these needs.

### SUMMARY OF THE INVENTION

It is an object of this invention to provide a new and useful apparatus and method that may be employed to treat food products, generally, and to thaw or defrost food products from a frozen state, specifically.

It is another object of the present invention to provide an apparatus that is inexpensive in manufacture and compact in size.

It is a further object of the present invention to provide a defrosting apparatus that is a relatively light unit that may easily fit on the counter-top of a typical kitchen.

Still a further object of the present invention is to provide an apparatus for defrosting a food product that is easy to use and clean.

According to the present invention, then, an apparatus is provided for treating a food product. Particularly, this apparatus is adapted for use in defrosting a food product. In any event, the apparatus broadly includes a water jacket that defines a water chamber adapted to receive and store water therein. The water jacket is configured to have an interior region with an entryway into the interior region and with the interior region sized and adapted to receive the food product therein. A layer of insulating material extends around a majority of the water jacket exteriorly thereof. A door is then moveably disposed relative to the water jacket and is moveable between an open position allowing access to the interior region through the entryway and a closed position enclosing the interior region. An inlet port is provided with the inlet port being in fluid communication with the water chamber so that water may be introduced into the water chamber.

In the exemplary embodiment, the water jacket is formed by an inner layer and an outer layer that are generally a common geometrical configuration but are spaced apart from one another with the inner layer being located inside of the outer layer. The inner layer is then formed by an inner lower jacket wall, an inner upper jacket wall, an inner jacket end wall and a pair of inner jacket sidewalls. The outer layer is spaced apart from the inner layer and is formed by an outer jacket lower wall, an outer jacket upper wall, an outer jacket end wall, a pair of outer jacket sidewalls and a jacket front wall that interconnects forward edges of the inner and outer layers thereby to define the water chamber.

In the exemplary embodiment, an outer shell is provided, and the inner water jacket is disposed within the outer shell. The insulating material is then disposed in a region between the water jacket and the outer shell. Here, the shell can include a shell bottom wall, a shell top wall, a shell back wall and a pair of shell sidewalls. The layer of insulating material then includes a bottom panel disposed between the outer jacket lower wall and the shell bottom wall, a top panel disposed between the outer jacket upper wall and the shell top wall, back panel disposed between the outer jacket end wall and the shell back wall and a pair of side panels respectively disposed between the outer jacket sidewalls and the shell sidewalls.

It may be appreciated that the outer shell, the water jacket and the layer of insulating material thus provide a housing that has an access opening with the interior of the housing adapted to receive the food product. The shell can include a front shell flange which forms the access opening. The insulating material can include a front insulating flange that extends alongside the front shell flange. If desired, the shell top wall may be arcuate in shape.

In the exemplary embodiment, the door is pivotally secured relative to the water jacket, and, specifically, is hingedly mounted so as to be pivotally secured to the housing. A latch is provided on the door and is operative to selectively retain the door in the closed position. The door may include an insulated core and, if desired, a handle can be provided to facilitate manipulation of the door.

A fill spout may be associated with the inlet port. The fill spout is moveable between a stored state wherein it's located within the inlet port and the water chamber and a fill state wherein it protrudes exteriorly of the inlet port. The inlet port can have a seat portion configured to support the fill spout in the stored state. Here, the inlet port may be constructed as a first tubular piece of a first diameter communicating with the water jacket and a second tubular piece of a second diameter greater than the first diameter which communicates with the shell. An annular web interconnects the first and second tubular pieces thereby to define a shoulder. The fill spout has an elongated flow tube and an outwardly extending tube flange. When in the stored state, the tube flange then can nest in the second tubular piece and be supported on the shoulder.

A fluid outlet port, and this outlet port are independent of the inlet port. The outlet port is in fluid communication with the water chamber. A removable cap may be sized and adapted to engage the inlet port, and a closure plug may be sized and adapted to engage the outlet port. The invention therefore contemplates that a quantity of water is disposed in the water chamber. Further, and if desired, a conductive plate may be disposed in the interior of the housing, such as in the interior region of the water jacket.

The present invention also provides a method of defrosting a frozen food product in an ambient environment. Here, the method may include the steps inherent in the above-described structure. More specifically, though, the method includes a step of providing an insulated water jacket defining a water chamber adapted to receive and store water therein with the water jacket configured to have an interior region sized and adapted to receive a food product therein with the water jacket substantially surrounding the interior region. The method then includes the steps of, in any order, filling the water chamber with water that is at a temperature above the ambient temperature of the ambient environment so that the water substantially surrounds the interior region, and placing the food product in the interior region wherein the frozen food product is isolated from the water. The method also includes the step of keeping the frozen food product in the interior region for a selected period of time.

This basic method according to the invention may include further processing steps, as well. For example, the period of time may be selected so as to be sufficient for the frozen food product to be defrosted under the influence of convection currents from the water chamber. The method may also include the step of placing a conductive plate underneath the frozen food product.

These and other objects of the present invention will become more readily appreciated and understood from a consideration of the following detailed description of the exemplary embodiment of the present invention when taken together with the accompanying drawings, in which:

### BRIEF DESCRIPTION OF THE DRAWINGS

FIG. 1 is a left side perspective view of a defrosting apparatus according to the exemplary embodiment of the present invention shown with the access door in a closed position;

FIG. 2 is a right side perspective view of the apparatus of FIG. 1 showing with the access door in an open position;

FIG. 3 is a side view in cross-section of the defrosting apparatus of the present invention taken about lines 3-3 of FIG. 1;

FIG. 4 is a front view in cross-section taken about lines 4-4 of FIG. 3;

FIG. 5 is a more detailed view, in partial cross-section, showing the fill spout of the present invention in a retracted position; and

FIG. 6 is a detailed cross-section view, similar to FIG. 5, but showing the fill spout in an extended position.

### DETAILED DESCRIPTION OF THE EXEMPLARY EMBODIMENT

The present invention broadly concerns food storage and handling. In particular, the present invention is directed to an apparatus and method for treating food products and, specifically, defrosting food products. The apparatus and method employs hot water as a heat sink yet defrosts the food product with convection air so as to avoid submerging the product in either a water bath or under a flowing stream of water. It should be understood, however, that the device could be used to cool food products as an alternative to defrosting. Here, cold water would be employed instead of hot water.

Broadly, the apparatus according to the present invention includes an outer shell surrounding an inner water jacket to form a housing that has an interior sized to receive a food product. The housing includes an insulating layer disposed between the water jacket and the outer shell so as to insulate the interior of the apparatus from the external environment. Hot tap water may be placed in the water jacket through a fill spout, and drained out of a closeable outlet.

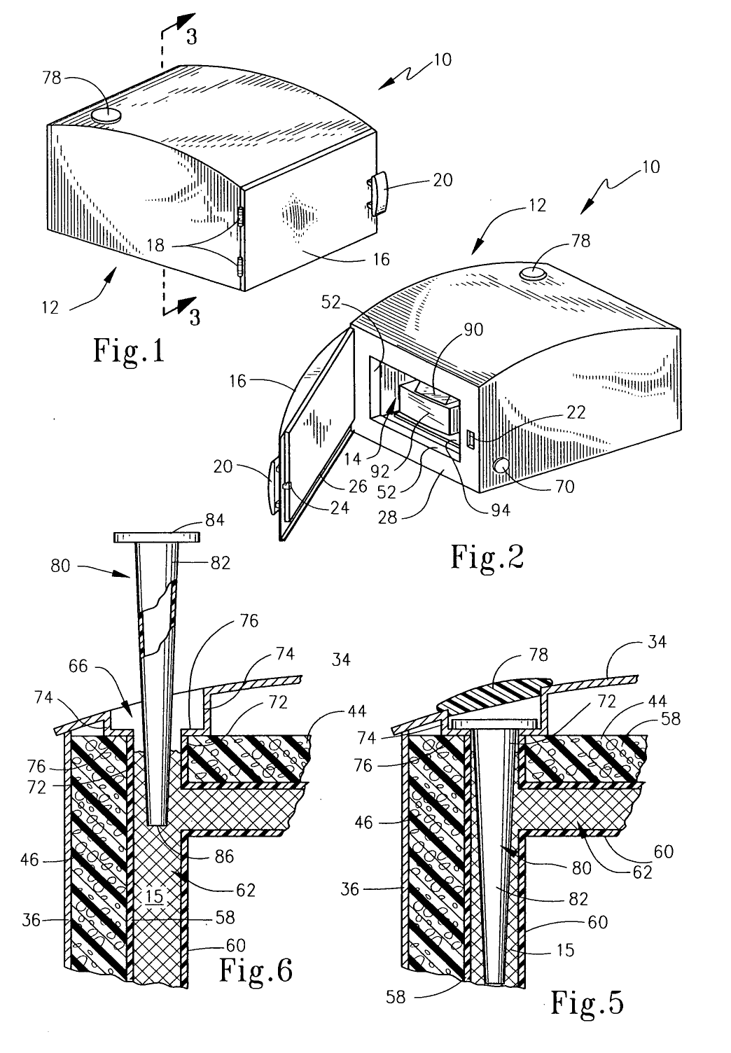

With reference, then, to FIGS. 1 and 2, the defrosting apparatus 10 according to the exemplary embodiment of the present invention, it is shown to include a housing 12 having an interior 14, the access to which is provided by an access door 16 that is pivotally attached to the front of housing 12 by means of a pair of hinges 18. In this manner, door 16 may pivot between a closed position, (FIG. 1) and an open position (FIG. 2). A handle 20 is provided on door 16 opposite hinges 18 to facilitate the opening and closing of door 16. Moreover, cooperative latch members 22 and 24 maintain the door 16 in a normally closed position. These latch members can be of many forms, as is known in the art, such as a metallic slot and a spring clip or a magnet and magnetic plate, for example. The inner side of door 16 may also be provided with a gasket 26 that extends around its outer periphery and which is positioned to abut a front edge surface 28 of housing 12.

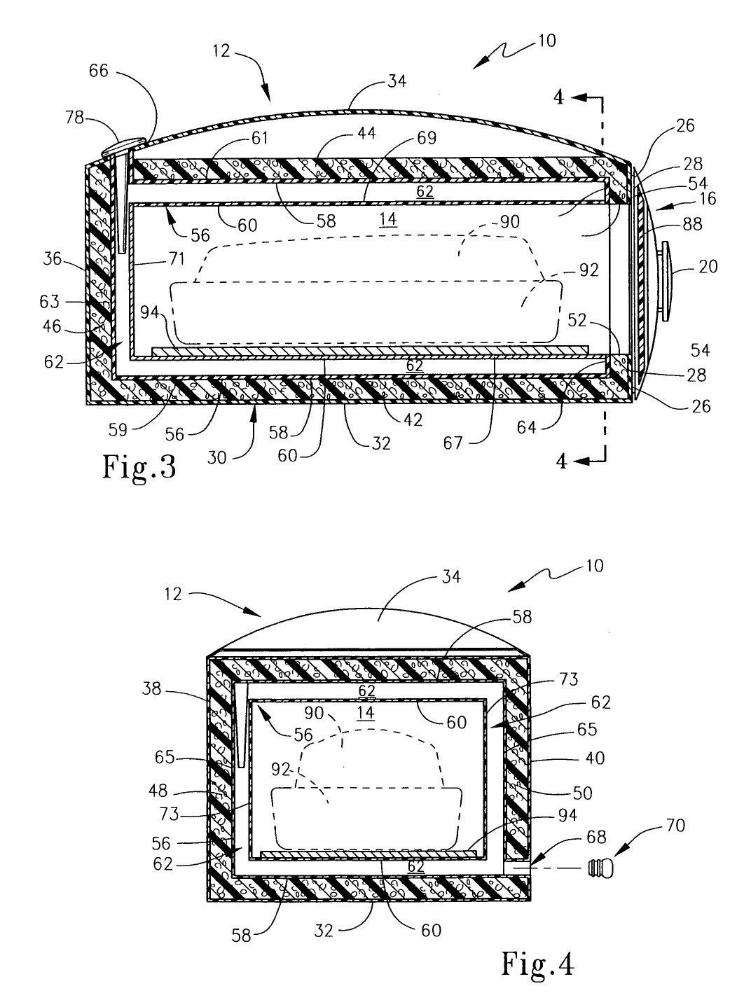

A more detailed structure defrosting apparatus 10 is shown in FIGS. 3 and 4. Here, it may be seen that housing 12 includes an outer shell 30 that includes a flat bottom wall 32, an arcuate top wall 34 a back wall 36 and a pair of sidewalls 38 and 40. Shell 30 may, for example, be constructed of a suitable formed metal, such as galvanized steel, stainless steel, aluminum and the like. In addition, it is possible to construct shell 30 out of a suitable plastic material that is either vacuum formed or injection molded. An insulation layer is enclosed by shell 30 and included a bottom panel 42 a top panel 44, a back panel 46 and a pair of side panels 48 and 50. The insulation layer also includes a front flange 52 which forms an entryway for interior 14 of defrosting apparatus 10. Moreover, it should be understood that shell 30 includes a front flange 54 that extends over flange 52 of the insulating layer. This insulating layer may be formed as a foam core of any suitable insulation material, including foamed rubbers, Styrofoam and the like. Preferably, this foam layer is approximately one inch thick.

A water jacket 56 is disposed inside of the insulating foam layer in confronting relationship thereto. Water jacket 56 may be formed between an outer plastic layer 58 and an inner plastic layer 60 that are generally geometrically similar in shape and are spaced apart from one another approximately one inch to define a water chamber 62 therebetween. Outer layer 58 therefore has an outer jacket lower wall 59, an outer jacket upper wall 61, and outer jacket end wall 63 and an pair of outer jacket side walls 65. Similarly, inner layer 60 has an inner jacket lower wall 67, an inner jacket upper wall 69, and inner jacket end wall 71 and an pair of inner jacket side walls 73. This chamber is enclosed, at the front edges of layers 58 and 60, by a front wall 64 so that chamber 62 can retain water without leaking.

Chamber 62 includes an inlet port 66 (described more thoroughly below) and an outlet port 68. Outlet port 68 includes a removable closure plug 70, and water may be placed in chamber 62 to inlet port 66 with plug 70 stopping outlet port 68. When a thawing operation is finished, plug 70 may be removed so as to drain water from chamber 62.

The structure of inlet port 66 is shown in greater detail in FIGS. 5 and 6. As is illustrated in these figures, outlet port 68 is formed by a cylindrical tubular extension 72 of chamber 62. A slightly larger in diameter tubular extension 74 is joined to tubular extension 72 by an annular web 76. Web 76 thus forms a shoulder for the outlet port 68, and outlet port 68 may be enclosed by means of a removable cap 78 that may be resiliently pressed therein.

A fill spout 80 is provided and is in the form of an elongated hollow tubular flow tube 82 that includes a flange 84. Flow tube 82 is generally circular in cross-section but decreases in diameter from flange 84 in a direction toward tip 86. Flange 84 is provided so that, when in a retracted or stored state (FIG. 5) flow tube 80 is prevented from falling in to the interior of chamber 62 by virtue of the fact that flange 84 will rest on the shoulder provided by annular web 76. To use fill spout 80, however, cap 78 is removed and fill spout 80 is withdrawn to the retracted position to a fill state shown in FIG. 6 where it protrudes from the water jacket and the shell. Hot tap water may then be directed through fill tube 80 into chamber 62.

In use, then, defrosting apparatus 10 is charged with hot water. To this end, plug 70 is placed in outlet port 68 to prevent leakage of the hot water. Cap 78 is then removed and fill spout 80 is advanced to the retracted position. Water is then placed in chamber 12 through fill spout 80 by insuring that and, in the process, air may exhaust upwardly through tubular extension 72 and 74 to exit to the external environment. After filling chamber 62 with hot tap water, fill spout 70 can be dropped back into its retracted state, as is shown in FIG. 5, and cap 78 replaced in position.

After charging defrosting apparatus 10 with hot water 15, as is shown in FIGS. 5 and 6, access door 16 is opened and the food item is placed therein. Thus, for example, as is shown in FIGS. 2-4, a quantity of food product 90 may be placed in a tray 92 and inserted into the interior 14 of defrosting apparatus 10. To this end, also, an optional thermal conductive plate 94 may be placed underneath tray 92 so that tray 92 rests on plate 94. The food product is thus substantially completely surrounded by the water jacket 56 so that the food product 90 is subjected to an elevated temperature that is at a non-cooking level.

Access door 16, of course, is closed during the defrosting apparatus with gasket 26 providing a generally airtight seal. To further retain the defrosting heat in the interior 14, it may be appreciated that door 16 may be formed as a shell filled with an inner core 88 of insulating material, as is shown in FIG. 3.

From the foregoing, it should be appreciated that a very efficient defrosting apparatus is provided that does not require an external power source. Moreover, it is relatively lightweight when unfilled with water so that it may be easily moved to the desired location for charging. Also, the unit can be designed to be relatively compact so as to have an overall height of eight inches, a width of ten inches and a length of seventeen inches. This creates a defrosting interior that is about four inches high, six inches wide and fourteen inches in length using a one-inch thickness of insulating material and a one-inch thick water jacket.

This structure provides advantages over conventional defrosting techniques. For example, it has no moving parts. It does not cook food during the defrosting process utilizing only hot tap water to defrost the food item. Moreover, it does not take electrical power to operate so it is a stand-alone unit that is lightweight and easily fits on a counter space of a typical kitchen. Finally, it can reduce the risk of bacteria by enclosing the food item in a closed environment during the defrosting process.

This unit has been tested and has been found to defrost food products in an efficient manner. For example, the following defrosting times have been noted:

| | | AMOUNT OF TIME TO |
|---|---|---|
| PRODUCT | QUANTITY | DEFROST |
| T-Bone Steaks | 1 Pound | 30 Minutes |
| Beef Roast | 3 Pounds | 2.5 Hours |
| Pork Roast | 4 Pounds | 1.5 Hours |
| Boneless Chicken Pieces | | 30 Minutes |
| Pork Chops | | 30 Minutes |
| Frozen Vegetables | 1 Box | 20 Minutes |
| Frozen Chicken | 4 Pounds | 1.5 Hours |

From the foregoing description, it should be appreciated that the present invention also contemplates a method of efficiently defrosting food products with the method steps being those inherent in the above-described description of the structure of the apparatus. Broadly, the method includes the steps of providing an insulated enclosure having an interior, placing a food product to be defrosted within the interior, substantially surrounding the interior with hot water while preventing contact between the water and the food product, and allowing sufficient time for the food product to be defrosted under the influence of convection air currents from the water jacket. The method can also include the step of placing a conductive plate underneath the food to increase thermal conduction and a heat sink for the heat transfer between the interior of the apparatus, the food product and the water jacket.

Accordingly, the present invention has been described with some degree of particularity directed to the exemplary embodiment of the present invention. It should be appreciated, though, that the present invention is defined by the following claims construed in light of the prior art so that modifications or changes may be made to the exemplary embodiment of the present invention without departing from the inventive concepts contained herein.

I claim:

1. Apparatus adapted for use in treating a food product, comprising:
(A) a water jacket defining a water chamber adapted to receive and store water therein, said water jacket configured to have an interior region with an entryway into the interior region, said interior region sized and adapted to receive a food product therein;
(B) a layer of insulating material extending around a majority of said water jacket exteriorly thereof;
(C) a door movably disposed relative to said water jacket and movable between an open position allowing access to the interior region through the entryway and a closed position enclosing the interior region; and
(D) an inlet port in fluid communication with the water chamber whereby a water may be introduced into the water chamber.

2. Apparatus according to claim 1 wherein said water jacket includes an inner layer formed by an inner lower jacket wall, an inner upper jacket wall, an inner jacket end wall and a pair of inner jacket side walls, an outer layer spaced-apart from said inner layer and formed by an outer jacket lower wall, an outer jacket upper wall, an outer jacket end wall, a pair of outer jacket side walls and a jacket front wall interconnecting forward edges of said inner and outer layers thereby to define the water chamber.

3. Apparatus according to claim 2 wherein said inner and outer layers are geometrically similar in shape.

4. Apparatus according to claim 2 wherein said layer of insulating material is in confronting relationship to said outer jacket lower wall, said outer jacket upper wall, said outer jacket end wall and said pair of outer jacket side walls.

5. Apparatus according to claim 1 wherein said door is pivotally secured relative to said water jacket.

6. Apparatus according to claim 5 including a latch operative to selectively retain said door in the closed position.

7. Apparatus according to claim 1 including a fill spout associated with the inlet port.

8. Apparatus according to claim 7 wherein said fill spout is movable between a stored state wherein it is located within the inlet port and the water chamber and a fill state wherein it protrudes exteriorly of the inlet port.

9. Apparatus according to claim 8 wherein said inlet port includes a seat portion configured to support said fill spout when in the stored state.

10. Apparatus according to claim 9 wherein said fill spout includes a flange, said seat portion including a shoulder sized and located to support said flange when in the stored state.

11. Apparatus according to claim 1 including an outer shell surrounding said layer of insulating material.

12. Apparatus according to claim 1 including an outlet port independent of said inlet port, said outlet port being in fluid communication with the water chamber.

13. Apparatus according to claim 1 wherein said door includes an insulating core disposed therein.

14. Apparatus according to claim 1 including a conductive plate disposed in the interior region.

15. Apparatus according to claim 1 including a quantity of water disposed in said water chamber.

16. Apparatus adapted for use in food treatment, comprising:
(A) a housing having an access opening and an interior adapted to receive a food product therein, said housing including:
(1) an outer shell,
(2) an inner water jacket disposed within said outer shell in surrounding relation to the interior of said housing, said water jacket defining a water chamber adapted to receive and store a water therein, and
(3) an insulating material disposed in a region between said water jacket and said outer shell;
(B) an access door pivotally secured to said housing and movable between an open position allowing access to the interior through the access opening and a closed position covering the access opening; and
(C) an inlet port in fluid communication with the water chamber whereby a water may be introduced into the water chamber.

17. Apparatus according to claim 16 including a gasket disposed on said door, said gasket configured to surround the access opening when the door is in the closed position thereby to substantially seal said door relative to said housing when said door is in the closed position.

18. Apparatus according to claim 16 wherein:
(A) said outer shell includes a shell bottom wall, a shell top wall, a shell back wall and a pair of shell sidewalls;
(B) wherein said water jacket includes an inner layer formed by an inner lower jacket wall, an inner upper jacket wall, an inner jacket end wall and a pair of inner jacket side walls, an outer layer spaced-apart from said inner layer and formed by an outer jacket lower wall spaced from said shell bottom wall, an outer jacket upper wall spaced from said shell top wall, an outer jacket end wall spaced from said shell back wall, a pair of outer jacket side walls respectively spaced from said shell sidewalls, and a jacket front wall interconnecting forward edges of said inner and outer layers thereby to define the water chamber; and
(C) said layer of insulating material includes a bottom panel disposed between said outer jacket lower wall and said shell bottom wall, a top panel disposed between said outer jacket upper wall and said shell top wall, a back panel disposed between said outer jacket end wall and said shell back wall and a pair of side panels respectively disposed between said outer jacket side walls wall and said shell sidewalls.

19. Apparatus according to claim 18 wherein said shell includes a front shell flange which forms the access opening, said insulating material including a front insulating flange that extends alongside said front shell flange.

20. Apparatus according to claim 18 wherein said shell top wall is arcuate in shape.

21. Apparatus according to claim 16 wherein said inlet port is constructed as a first tubular piece of a first diameter communicating with said water jacket, a second tubular piece of a second diameter greater than the first diameter and communicating with said shell, and an annular web interconnecting said first and second tubular pieces. thereby to define a shoulder.

22. Apparatus according to claim 21 including a fill spout having an elongated flow tube and an outwardly extending tube flange, said fill spout associated with the inlet port and movable between a stored state wherein said flow tube is located within the water chamber and a fill state wherein said fill spout protrudes exteriorly of the inlet port, said shoulder sized and located to support said tube flange when said fill spout is in the stored state.

23. Apparatus according to claim 22 including a removable cap sized and adapted to engage said inlet port.

24. Apparatus according to claim 16 including an outlet port independent of said inlet port, said outlet port being in fluid communication with the water chamber.

25. Apparatus according to claim 24 including a removable closure plug sized and adapted to engage said outlet port.

26. Apparatus according to claim 16 including a conductive plate disposed in the interior of said housing.

27. Apparatus according to claim 16 including a quantity of water disposed in said water chamber.

28. A method of defrosting a frozen food product in an ambient environment comprising:
(A) providing an insulated water jacket defining a water chamber adapted to receive and store a water therein and configured to have an interior region sized and adapted to receive a food product therein with the water jacket substantially surrounding the interior region;
(B) in any order:
(1) filling the water chamber with water that is at a temperature above an ambient temperature of the ambient environment so that said water substantially surrounds the interior region, and
(2) placing the frozen food product in the interior region wherein said frozen food product is isolated from said water; and
(C) keeping said frozen food product in the interior region for a selected period of time.

29. A method according to claim 28 wherein the selected period of time is sufficient for the frozen food product to be defrosted under the influence of convection currents from said water in the water chamber.

30. A method according to claim 28 including the step of placing a conductive plate underneath said frozen food product.
